(19) United States
(12) Patent Application Publication
(10) Pub. No.: US 2019/0114994 A1
(43) Pub. Date: Apr. 18, 2019

(54) IMAGE PROCESSING APPARATUS, IMAGE PROCESSING METHOD, AND NON-TRANSITORY COMPUTER READABLE MEDIUM

(71) Applicant: CANON KABUSHIKI KAISHA, Tokyo (JP)

(72) Inventors: Masahiro Sato, Tokyo (JP); Hirofumi Urabe, Tokyo (JP)

(21) Appl. No.: 16/156,262

(22) Filed: Oct. 10, 2018

(30) Foreign Application Priority Data
Oct. 16, 2017 (JP) 2017-200407

(51) Int. Cl. G09G 5/10; G09G 5/02; G09G 5/04

(52) U.S. Cl. CPC G09G 5/10; G09G 5/028; G09G 5/04; G09G 5/06; G09G 2320/0686; G09G 2320/0271; G09G 2320/066; G09G 2320/0666

(57) ABSTRACT

An image processing apparatus includes: a converting unit configured to convert a color of a target region of an input image into a conversion color; and a display control unit configured to display an image based on an image acquired by converting the color of the target region, wherein in a case that a brightness of the target region is included in a first partial range, the converting unit converts the color of the target region into a monochrome color, in a case that the brightness of the target region is included in a second partial range, the converting unit converts the color of the target region into a conversion color corresponding to the second partial range, and regarding each of the plurality of second partial ranges, a brightness of the conversion color is higher as a brightness of the second partial range is higher.

### BACKGROUND OF THE INVENTION

### Field of the Invention

The present invention relates to an image processing apparatus, an image processing method, and a non-transitory computer readable medium.

### Description of the Related Art

As an assist function for a user to check the brightness distribution of the input image data, a function to convert the color of each pixel of the input image data into a conversion color, which is different among a plurality of partial brightness ranges in a brightness range of the input image data, is available. An example of the prior art related to this assist function is disclosed in Japanese Patent Application Publication No. 2015-109563. According to the technique disclosed in Japanese Patent Application Publication No. 2015-109563, a color of a waveform on a waveform monitor is converted into a color that is the same as the conversion color.

### SUMMARY OF THE INVENTION

In the prior art, however, the correspondence between the conversion color and the brightness of the input image data must be known in order to know the brightness distribution of the input image data. Because of this, the user cannot easily know the brightness distribution of the input image data.

The present invention in its first aspect provides an image processing apparatus, comprising:

at least one processor and/or at least one circuit to perform the operations of the following units:

a converting unit configured to convert a color of a target region of an input image into a conversion color corresponding to a brightness of the target region; and

a display control unit configured to display an image on a display unit based on an image acquired by converting the color of the target region into the conversion color, wherein

in a case that the brightness of the target region is included in a first partial range among a plurality of partial ranges obtained by dividing a brightness range of the input image, the converting unit converts the color of the target region into a monochrome color,

in a case that the brightness of the target region is included in one of a plurality of second partial ranges, each of which is different from the first partial range, among the plurality of partial ranges, the converting unit converts the color of the target region into a conversion color corresponding to the one of the plurality of second partial ranges, and

regarding each of the plurality of second partial ranges, a brightness of the conversion color is higher as a brightness of the second partial range is higher.

The present invention in its second aspect provides an image processing method, comprising:

converting a color of a target region of an input image into a conversion color corresponding to a brightness of the target region; and

displaying an image on a display unit based on an image acquired by converting the color of the target region into the conversion color, wherein

in the converting,

in a case that the brightness of the target region is included in a first partial range among a plurality of partial ranges obtained by dividing a brightness range of the input image, the color of the target region is converted into a monochrome color,

in a case that the brightness of the target region is included in one of a plurality of second partial ranges, each of which is different from the first partial range, among the plurality of partial ranges, the color of the target region is converted into a conversion color corresponding to the one of the plurality of second partial ranges, and

regarding each of the plurality of second partial ranges, a brightness of the conversion color is higher as a brightness of the second partial range is higher.

The present invention in its third aspect provides a non-transitory computer readable medium that stores a program, wherein

the program causes a computer to execute:

converting a color of a target region of an input image into a conversion color corresponding to a brightness of the target region; and

displaying an image on a display unit based on an image acquired by converting the color of the target region into the conversion color, wherein

in the converting,

in a case that the brightness of the target region is included in a first partial range among a plurality of partial ranges obtained by dividing a brightness range of the input image, the color of the target region is converted into a monochrome color,

in a case that the brightness of the target region is included in one of a plurality of second partial ranges, each of which is different from the first partial range, among the plurality of partial ranges, the color of the target region is converted into a conversion color corresponding to the one of the plurality of second partial ranges, and

regarding each of the plurality of second partial ranges, a brightness of the conversion color is higher as a brightness of the second partial range is higher.

Further features of the present invention will become apparent from the following description of exemplary embodiments with reference to the attached drawings.

### BRIEF DESCRIPTION OF THE DRAWINGS

FIG. 1 is a block diagram depicting a configuration example of a display apparatus according to Example 1;

FIGS. 2A and 2B are diagrams depicting examples of a correspondence between the input brightness and the display brightness according to Example 1;

FIG. 3 is a diagram depicting an example of a correspondence between a partial brightness range and a conversion color according to Example 1;

FIG. 4 is a diagram depicting a conventional example of a correspondence between the input brightness and the display brightness;

FIG. 5 is a flow chart depicting an example of a processing flow of a color conversion processing according to Example 1;

FIG. 6 is a table indicating an example of a correspondence between a display target range and a brightness gain according to Example 1;

FIGS. 7A and 7B are tables indicating an example of the correspondence between a partial brightness range and RGB values according to Example 1;

FIG. 8 is a diagram depicting an example of a correspondence between the input brightness and the display brightness according to Example 1;

FIGS. 9A and 9B are diagrams depicting an example of a correspondence between the input brightness and the display brightness according to Example 1;

FIGS. 10A and 10B are diagrams depicting an example of a correspondence between the input brightness and the display brightness according to Example 1;

FIGS. 11A and 11B are diagrams depicting an example of a correspondence between the input brightness and the display brightness according to Example 1;

FIG. 12 is a block diagram depicting a configuration example of a display apparatus according to Example 2;

FIG. 13 is a table indicating an example of the correspondence between the upper limit display brightness and the brightness gain according to Example 2; and

FIG. 14 is a diagram depicting an example of a correspondence between the input brightness and the display brightness according to Example 2.

### DESCRIPTION OF THE EMBODIMENTS

### Example 1

Example 1 of the present invention will be described.

In the following, a display apparatus having an image processing apparatus according to Example 1 will be described as an example. The display apparatus is, for example, a liquid crystal display apparatus, an organic electro luminescence (EL) display apparatus, a plasma display apparatus, a micro electro mechanical system (MEMS) shutter type display apparatus or the like.

The image processing apparatus may be an apparatus separated from the display apparatus. An image processing apparatus that is separated from the display apparatus is, for example, a personal computer (PC), a playback apparatus (e.g. Blu-ray player), a server apparatus or the like.

Configuration

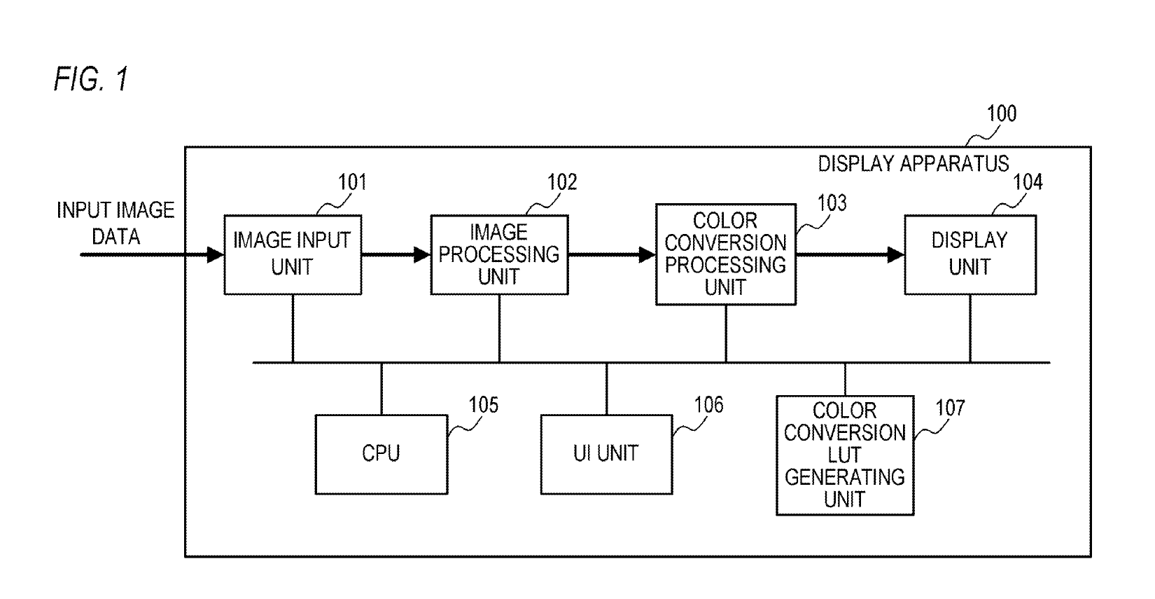

FIG. 1 indicates a configuration example of a display apparatus 100 according to Example 1. The display apparatus 100 includes an image input unit 101, an image processing unit 102, a color conversion processing unit 103, a display unit 104, a CPU 105, a user interface (UI) unit 106, and a color conversion LUT generating unit 107. The range of the display brightness (brightness on screen) of the display apparatus 100 is not especially limited, but in Example 1, the range of the display brightness is assumed to be at least 0 cd/m² and not more than 1000 cd/m².

The image input unit 101 acquires image data (input image data) and outputs the input image data to the image processing unit 102. In Example 1, the image input unit 101 acquires the input image data from outside the display apparatus 100 (image processing apparatus). In concrete terms, the image input unit 101 has a serial digital interface (SDI) input terminal conforming to SDI standards, and acquires the SDI signal via the SDI input terminal from outside the display apparatus 100. Then the image input unit 101 converts the SDI signal into the image data having a data format that can be processed within the display apparatus 100, and outputs the image data after conversion to the image processing unit 102.

The method of acquiring the input image data is not especially limited. For example, the display apparatus 100 (image processing apparatus) may include a storage unit to store image data, so that the image input unit 101 reads image data (input image data) from the storage unit. The image data (image signal) that is inputted to the image input unit 101 is not limited to an SDI signal.

The dynamic range (brightness range) of the input image data is not especially limited, but in Example 1, it is assumed that the input image data has a wide dynamic range. The wide dynamic range is called “high dynamic range (HDR)” and a dynamic range narrower than HDR is called “standard dynamic range (SDR)”. The image data having HDR is called “HDR image data”, and the image data having SDR is called “SDR image data”.

The number of bits of the gradation value (bit depth) of the input image data is not especially limited, but in Example 1, the gradation value of the input image data is assumed to be a 10-bit value (0 to 1023).

The input image system (standard; gradation characteristics) is not especially limited, but in Example 1, the input image data system is assumed to conform to the ST. 2084 standardized by the Society of Motion Picture and Television Engineers, Inc. (SMPTE). The ST. 2084 standard defines an HDR image data be that can transmitted using a cable, such as an SDI cable. The ST. 2084 is a standard based on human visual characteristics, and defines the brightness of the HDR image data as the absolute brightness. In ST. 2084, the absolute brightness that is at least 0 cd/m² and not more than 10000 cd/m² is handled. As mentioned above, in Example 1, the upper limit of the display brightness (upper limit display brightness) is 1000 cd/m², and the display apparatus 100 cannot implement a 1000 cd/m² or higher display brightness.

The image processing unit 102 performs a gradation correction processing and a range correction processing for the input image data outputted from the image input unit 101. The gradation correction processing is processing to correct (convert) a gradation value using a predetermined one-dimensional look up table (1D LUT) in accordance with the gradation setting. Instead of 1D LUT, a three-dimensional look up table (3D LUT) or a function may be used. The range correction processing is processing to correct (convert) the gradation value based on the range setting. The range setting is a setting of a target range of the display (display target range) in the dynamic range of the input image data. The display target range may be fixed, but in Example 1, it is assumed that the display target range is changeable.

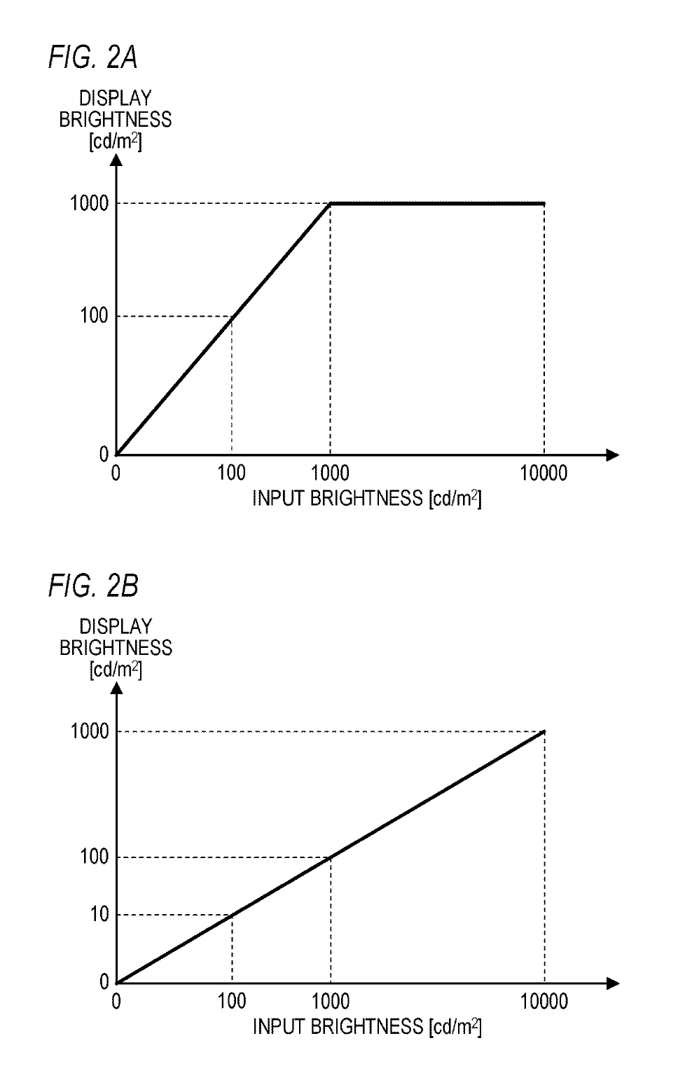

FIGS. 2A and 2B indicate examples of a correspondence between the brightness of the input image data (absolute brightness according to ST. 2084; input brightness) and the display brightness in accordance with the input image data. When the display target range is at least 0 cd/m² and not more than 1000 cd/m2, the range correction processing is performed to implement the correspondence in FIG. 2A. According to the correspondence in FIG. 2A, the input brightness that is at least 0 cd/m² and not more than 1000 cd/m² is displayed at a display brightness that is the same as this input brightness (non-compression display). The input display that is more than 1000 cd/m² and not more than 10000 cd/m² is displayed at the upper limit display brightness 1000 cd/m² (overexposure display: clip display). When the display target range is at least 0 cd/m² and not more than 10000 cd/m², the range correction processing is performed to implement the correspondence in FIG. 2B. According to the correspondence in FIG. 2B, the input brightness range (range of input brightness) that is at least 0 cd/m² and not more than 10000 cd/m² is compressed to within the display brightness range (range of display brightness) that is at least 0 cd/m² and not more than 1000 cd/m² and compressed in this compressed state (compressed display). In this way, the display brightness in accordance with the input image data changes in accordance with the display target range.

If a false color function is enabled, the image processing unit 102 performs monochrome processing to convert a color of each pixel into a monochrome color, for the image data after the gradation correction processing and the range correction processing are performed. The false color function is an assist function for the user to check the brightness distribution of the input image data, and is a function to convert a color of each pixel of the input image data into a conversion color, which is different among a plurality of partial brightness ranges in the dynamic range of the input image data. The conversion of a color is also called “coloring”, and the false color function is also called “color conversion function” or “coloring function”.

Then the image processing unit 102 outputs the image data, after the above mentioned image processing (gradation correction processing, range correction processing, monochrome processing) is performed, to the color conversion processing unit 103. Hereafter the image data outputted from the image processing unit 102 is called “processed image data”.

If the false color function is enabled, the color conversion processing unit 103 converts the color of each pixel of the processed image data outputted from the image processing unit 102 into a conversion color (color conversion processing). In concrete terms, the color conversion processing unit 103 corrects (converts) each gradation value of the processed image data using a 1D LUT generated by the color conversion LUT generating unit 107. Thereby the display image data is generated. Instead of the 1D LUT, a 3D LUT or a function may be used. The color conversion processing unit 103 outputs the display image data to the display unit 104. If the false color function is disabled, the color conversion processing unit 103 outputs the display image data that is the same as the processed image data.

The display unit 104 performs display control when an image based on the display image data outputted from the color conversion processing unit 103 is displayed on the screen of the display unit 104. For the display unit 104, a self-emitting type display panel, or a combination of a light-emitting unit and a transmission type display panel, for example, can be used. The self-emitting type display panel displays an image by emitting light based on the display image data. The light-emitting unit irradiates light to the rear face of the transmission type display panel. The transmission type display panel displays an image by transmitting light emitted from the light-emitting unit based on the display image data. In a liquid crystal display apparatus, the light-emitting unit is called a “backlight unit”, and the transmission type display panel is called a “liquid crystal panel”.

The CPU 105 is a processor which controls operation of the display apparatus 100 (each functional unit of the display apparatus 100). For example, the display apparatus 100 has a storage unit (non-volatile memory) which stores a program, and the CPU 105 controls the operation of the display apparatus 100 by reading the program from the storage unit and executing the program.

The UI unit 106 is a user interface which accepts user operation performed for the display apparatus 100 (image processing apparatus). Then the UI unit 106 outputs an operation signal in accordance with the performed user operation to other functional units (e.g. image processing unit 102, color conversion processing unit 103, CPU 105, color conversion LUT generating unit 107) of the display apparatus 100. The UI unit 106 is, for example, buttons disposed on the display apparatus 100 and a touch panel installed in the display unit 104. An operation unit (e.g. controller, keyboard, mouse) that can be detachably attached to the display apparatus 100 may be used as the UI unit 106.

The UI unit 106 accepts, for example, a user operation for gradation setting, a user operation for range setting, and a user operation for false color setting (setting enable/disable of false color function). The UI unit 106 outputs an operation signal in accordance with the user operation (e.g. gradation setting, range setting, false color setting) to the CPU 105, and the CPU 105 performs setting in accordance with this operation signal.

The color conversion LUT generating unit 107 generates a 1D LUT for color conversion processing in accordance with the gradation setting, range setting and false color setting. The format of the pixel values of the input image data, processing image data, display image data and the like is not especially limited, but in Example 1, the pixel values are assumed to be RGB values. Then the color conversion LUT generating unit 107 generates a 1D LUT for converting the R value, a 1D LUT for converting the G value, and a 1D LUT for converting the B value. If the false color function is disabled, the color conversion LUT generating unit 107 generates a 1D LUT in which the gradation value is not converted, and the color conversion processing unit 103 performs the color conversion processing using the 1D LUT in which the gradation value is not converted. In the case when the false color function is disabled, the color conversion processing unit 103 may omit the color conversion processing, without the color conversion LUT generating unit 107 generating the 1D LUT.

Color Conversion Processing

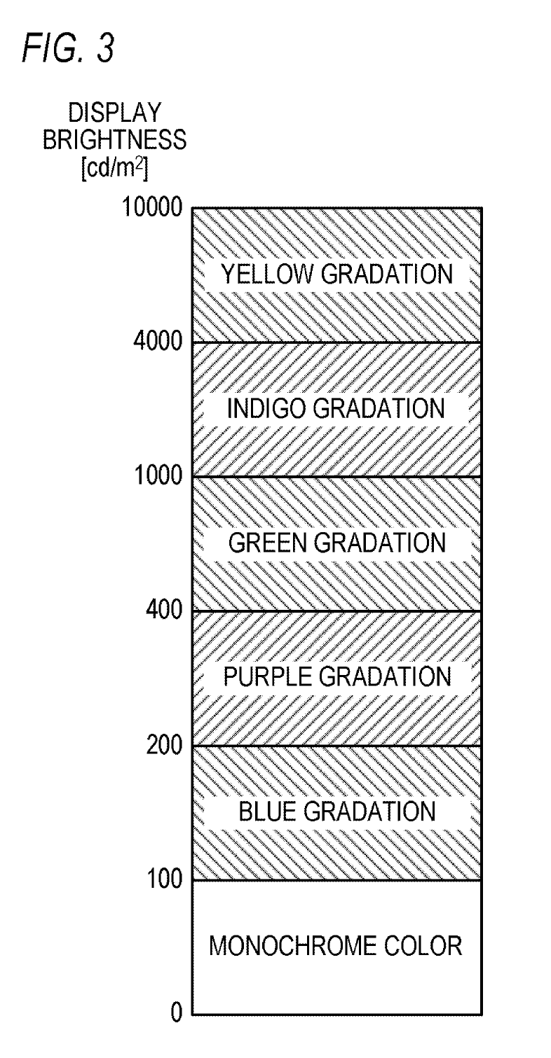

FIG. 3 is an example of the correspondence between a partial brightness range and a conversion color. In Example 1, a plurality of partial brightness ranges do not include a range of input brightness that is not more than a predetermined brightness. In concrete terms, as illustrated in FIG. 3, five partial brightness ranges constituting the input brightness range, that is at least 100 cd/m² and not more than 10000 cd/m², are defined. The input brightness range that is at least 0 cd/m² and not more than 100 cd/m² is an SDR range. A color of a pixel having an input brightness in the SDR range (specific pixel: SDR pixel) is not converted from the monochrome color. A color of a pixel having an input brightness that is at least 100 cd/m² and not more than 200 cd/m² is converted into blue, and a color of a pixel having an input brightness that is at least 200 cd/m² and not more than 400 cd/m² is converted into purple. A color of a pixel having an input brightness that is at least 400 cd/m² and not more than 1000 cd/m² is converted into green, and a color of a pixel having an input brightness that is at least 1000 cd/m² and not more than 4000 cd/m² is converted into indigo. A color of a pixel having an input brightness that is at least 4000 cd/m² and not more than 10000 cd/m² is converted into yellow. Thereby the user can check the input brightness by the color (conversion color).

Further, according to Example 1, a color conversion processing is performed such that the display brightness of the conversion color is higher as the input brightness is higher in each of the plurality of partial brightness ranges. In concrete terms, in each of the plurality of partial brightness ranges, the color conversion processing is performed so that the display brightness of the conversion color continuously increases as the input brightness increases (gradation display). Thereby the user can also check the distribution of the input brightness in each partial brightness range. For example, the user can know that the image region that is light blue is an image region having an input brightness close to 200 cd/m², and the image region that is dark blue is an image region having an input brightness close to 100 cd/m².

The number of partial brightness ranges is not especially limited. To check the distribution of the input brightness, however, it is preferable that the number of partial brightness ranges is at least three. The plurality of partial brightness ranges may constitute the entire dynamic range of the input image data. The plurality of partial brightness ranges need not be continuous. In each of the plurality of partial brightness ranges, the display brightness of the conversion color may discontinuously increase as the input brightness increases. In each of the plurality of partial brightness ranges, the display brightness of the conversion color may be consistent. The maximum brightness of the input brightness range, in which conversion into a conversion color is not performed (SDR range), is not especially limited. The image processing unit 102 may perform the monochrome processing only for the SDR pixels. The image processing unit 102 may not perform the monochrome processing at all.

### Problem Solved by Example 1

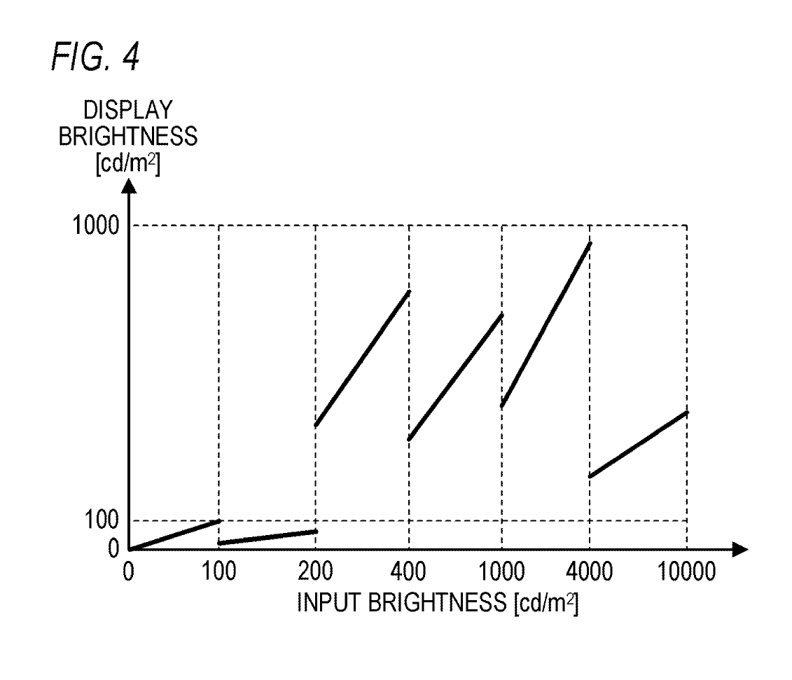

In a conventional color conversion processing, as shown in FIG. 4, the high-low relationship of the display brightness of the conversion colors among a plurality of partial brightness ranges is unrelated to the high-low relationship of the input brightness among the plurality of partial brightness ranges. For example, in FIG. 4, the display brightness of a conversion color in the partial brightness range that is at least 1000 cd/m² and not more than 4000 cd/m² is higher than the display brightness of a conversion color in the partial brightness range that is at least 4000 cd/m² and not more than 10000 cd/m². Therefore the user cannot intuitively (easily) know the distribution of the input brightness by the display brightness. To know the distribution of the input brightness, the user must know the correspondence between the input brightness and the conversion color. In order to know the correspondence between the input brightness and the conversion color, such a guide as a waveform monitor or a list is displayed as an on screen display (OSD) image.

Further, in the prior art, if the display target range is a display brightness range that is at least 0 cd/m² and not more than 10000 cd/m², the correspondence in FIG. 2B is implemented in the SDR range. According to the correspondence in FIG. 2B, the SDR range that is at least 0 cd/m² and not more than 100 cd/m² is compressed to the display brightness range that is at least 0 cd/m² and not more than 10 cd/m², and is displayed in this compressed state. Therefore the image region in the SDR range is displayed as dark, and the user cannot easily know the gradation of the image region in the SDR range.

Therefore in Example 1, the color conversion processing unit 103 performs the color conversion processing so that the high-low relationship of the display brightness of the conversion color among the plurality of partial brightness ranges corresponds to the high-low relationship of the input brightness among the plurality of partial brightness ranges. As a result, the user can intuitively know that the display brightness of the conversion color corresponds to the input brightness, and can also intuitively know the distribution of the input brightness, without knowing the actual correspondence between the input brightness and the conversion color.

Further, in Example 1, the color conversion processing unit 103 performs the color conversion processing, so that the display brightness of the SDR pixel is increased from the display brightness value in accordance with the input image data. As a result, the visibility of the image region in the SDR range improves, and the user can easily know the gradation of the image region in the SDR range. The brightness control to increase the display brightness of the SDR pixel may be performed by a functional unit that is different from the color conversion processing unit 103.

Processing Flow of Color Conversion Processing

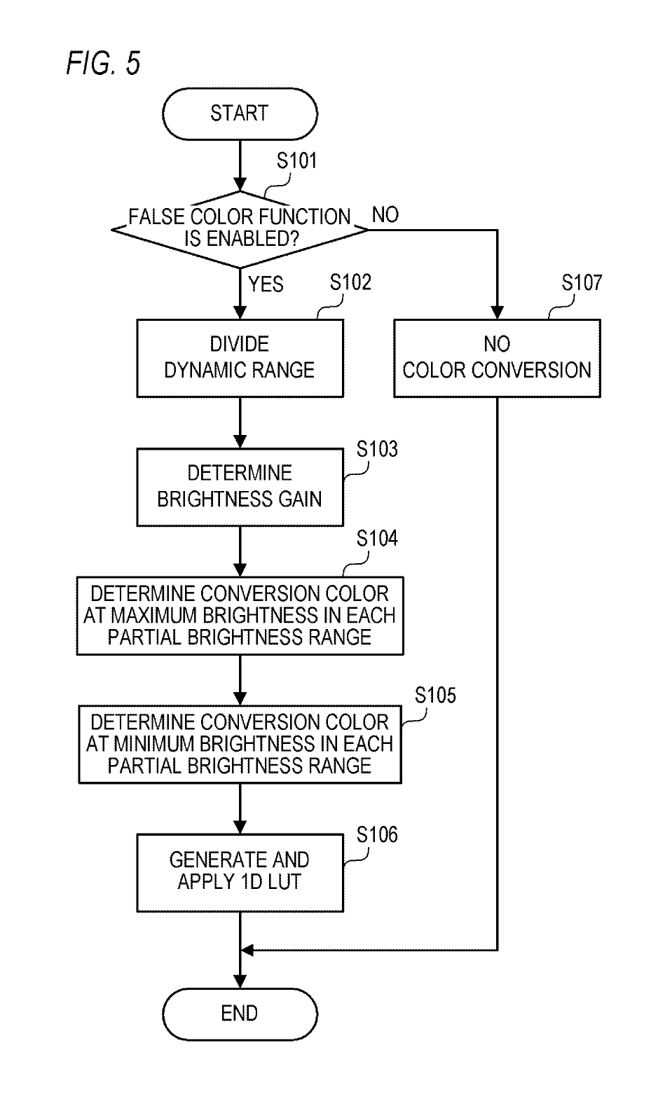

A processing flow of the color conversion processing in Example 1 will be described with reference to FIG. 5. FIG. 5 is an example of the processing flow of the color conversion processing according to Example 1.

First in S101, the color conversion LUT generating unit 107 determines whether the false color function is enabled. If it is determined that the false color function is enabled, processing advances to S102, and if it is determined that the false color function is disabled, processing advances to S107. In S107, as the 1D LUT for color conversion processing, the color conversion LUT generating unit 107 generates a 1D LUT, in which the gradation value is not converted. Then the color conversion processing unit 103 performs the color conversion processing using the generated 1D LUT. Then this processing flow ends.

In S102 the color conversion LUT generating unit 107 divides the dynamic range of the input image data into a plurality of input brightness ranges, including the SDR range and a plurality of partial brightness ranges. In Example 1, the SDR range and five partial brightness ranges are acquired by dividing the dynamic range of the input image data, as illustrated in FIG. 3.

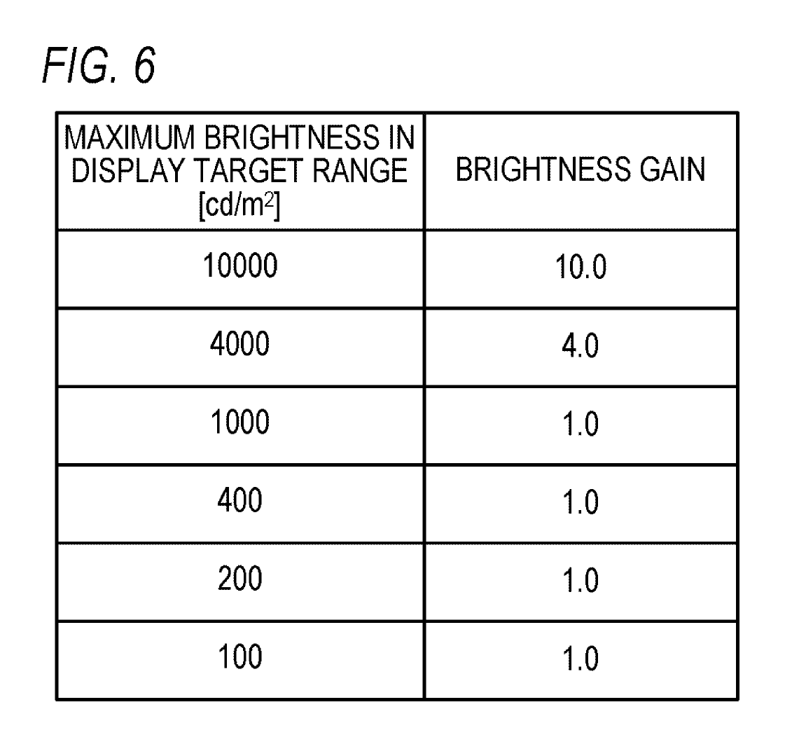

Then in S103, the color conversion LUT generating unit 107 determines the degree of increasing the display brightness of the SDR pixel. In Example 1, the color conversion LUT generating unit 107 determines a higher degree of increase as the display target range is wider. Further, in Example 1, the color conversion LUT generating unit 107 determines the increase rate of the display brightness (brightness gain) for the degree of increase. In concrete terms, as indicated in FIG. 6, the color conversion LUT generating unit 107 determines “1.0” as the brightness gain when the maximum brightness of the display target range is not more than 1000 cd/m². The color conversion LUT generating unit 107 determines “4.0” as the brightness gain when the maximum brightness of the display target range is 4000 cd/m². Further, the color conversion LUT generating unit 107 determines “10.0” as the brightness gain when the maximum brightness of the display target range is 10000 cd/m².

According to Example 1, if the maximum brightness of the display target range is more than 1000 cd/m², a brightness gain of more than “1.0” is determined (set). Therefore when the maximum brightness of the display target range is more than 1000 cd/m², the display brightness of the SDR pixel is increased at the brightness gain that is set. As a result, the image region in the SDR range can be displayed at a relatively high display brightness, and the user can easily know the gradation of the image region in the SDR range. As the display target range is wider, the display brightness in accordance with the input image data is lower. In Example 1, if the maximum brightness of the display target range is more than 1000 cd/m², the higher degree of increase is determined as the display target range is wider, that is, the larger brightness gain is determined as the display target range is wider. As a result, a drop in the display brightness of the SDR pixel, caused by an increase in the display target range, can be suppressed, and the above mentioned effect can be implemented with more certainty.

The correspondence between the display target range (maximum brightness of the display target range) and the brightness gain is not limited to the correspondence in FIG. 6. For the degree of increase, the increase amount (brightness offset) may be determined and used instead of the increase rate (brightness gain). The degree of increase may be a fixed value.

Then in S104, the color conversion LUT generating unit 107 determines the pixel values (RGB values) of the conversion color corresponding to the maximum brightness in each of the five partial brightness ranges respectively. The correspondence of the R, G and B values and the brightness value Y is given by the following Expression 1. The brightness value Y corresponds to the display brightness. In Example 1, using Expression 1, the color conversion LUT generating unit 107 determines the RGB values, which implement a greater brightness value Y as the maximum brightness of the partial brightness range is higher, as the RGB values of the conversion color corresponding to the highest brightness in this partial brightness range.

Y=0.2126×R+0.7152×G+0.0722×B (Expression 1)

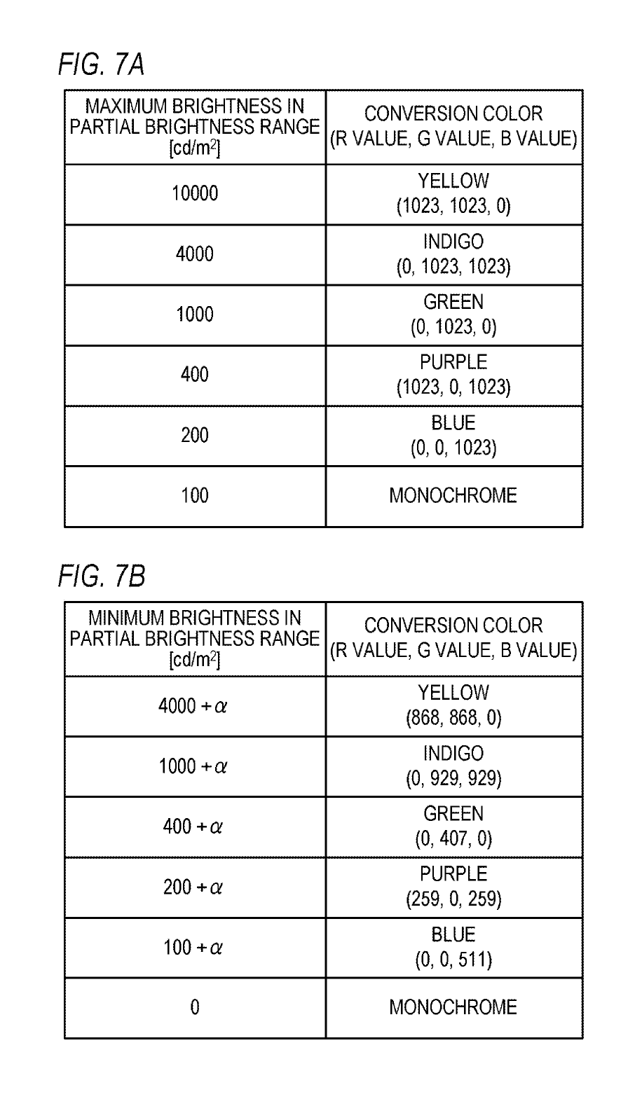

To easily distinguish the conversion colors among the five partial brightness ranges, it is preferable to use 0 or 1023 as the R, G and B values of the conversion color corresponding to the highest brightness of each partial brightness range. Further, to distinguish between the SDR pixel of the monochrome color and the pixel of the conversion color, it is preferable that gray scale colors (including black, of which R, G and B values are all 0, and white of which R, G and B values are all 1023) are not used for the conversion colors. In Example 1, it is assumed that the R, G and B values of the conversion color corresponding to the highest brightness in each partial brightness range are determined, as indicated in FIG. 7A.

Then in S105, the color conversion LUT generating unit 107 determines the pixel values (RGB values) of the conversion color corresponding to the minimum brightness of each of the five partial brightness ranges respectively. The color conversion LUT generating unit 107 determines the RGB values of the conversion color corresponding to the minimum brightness of the partial brightness range based on the RGB values determined in S104 and Expression 1, for example. In Example 1, the color conversion LUT generating unit 107 determines the RGB values of the conversion color corresponding to the minimum brightness of the partial brightness range, so that the display brightness of the conversion color continuously increases as the input brightness increases in the input brightness range constituted of five partial brightness ranges. In Example 1, it is assumed that the RGB values of the conversion color corresponding to the minimum brightness of the partial brightness range are determined, as indicated in FIG. 7B. “α” in FIG. 7B denotes a minimum increase amount of the input brightness.

Then in S106, the color conversion LUT generating unit 107 generates a 1D LUT for color conversion processing based on the brightness gain determined in S103, the RGB values determined in S104, and the RGB values determined in S105. Then the color conversion processing unit 103 performs the color conversion processing using the generated 1D LUT. Then this processing flow ends.

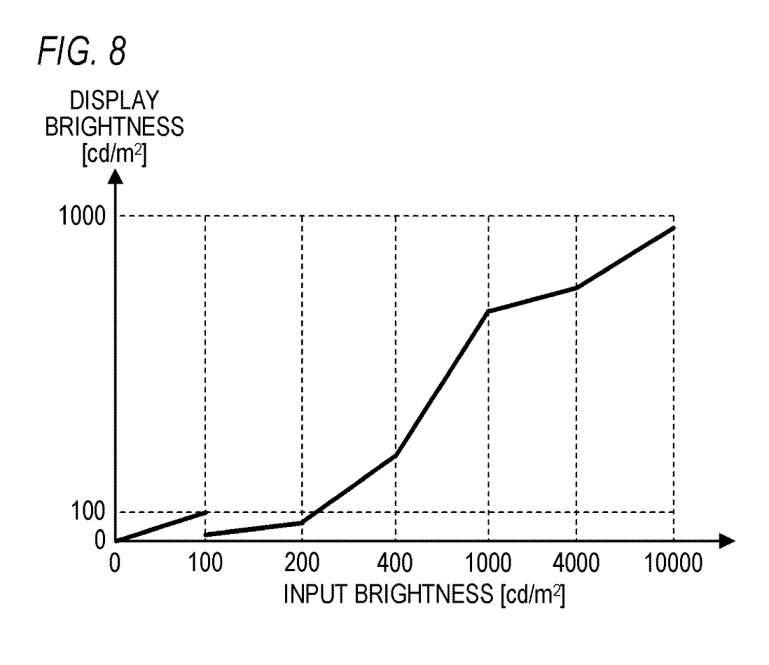

FIG. 8 indicates a correspondence between the input brightness and the display brightness when the display target range is the display brightness range that is at least 0 cd/m² and not more than 10000 cd/m², and when the false color function is enabled. In FIG. 8, the high-low relationship of the display brightness of the conversion color among a plurality of partial brightness ranges corresponds to the high-low relationship of the input brightness among the plurality of partial brightness ranges. In concrete terms, in the input brightness range constituted of five partial brightness ranges, the display brightness of the conversion color continuously increases as the input brightness increases. As a result, the user can intuitively know that the display brightness of the conversion color corresponds to the input brightness, and can also intuitively know the distribution of the input brightness without knowing the actual correspondence between the input brightness and the conversion color.

Further, by the brightness gain “10.0”, the display brightness of the SDR pixel is increased to 10 times the display brightness in accordance with the input image data. Therefore the SDR range that is at least 0 cd/m² and not more than 100 cd/m² is displayed in the display brightness range that is the same as the SDR range, without being compressed to the display brightness range that is at least 0 cd/m² and not more than 10 cd/m². As a result, the visibility of the image region in the SDR range improves, and the user can easily know the gradation of the image region in the SDR range.

When the display target range is the display brightness range that is at least 0 cd/m² and not more than 1000 cd/m², the brightness gain is “1.0”, hence the SDR pixel is displayed at the display brightness in accordance with the input image data. Therefore the correspondence between the input brightness and the display brightness becomes the correspondence indicated in FIG. 8.

### CONCLUSION

As described above, according to Example 1, the high-low relationship of the display brightness of the conversion color among the plurality of partial brightness ranges corresponds to the high-low relationship of the input brightness among the plurality of partial brightness ranges. As a result, the user can easily know the brightness distribution of the input image data.

Other than the method of defining the brightness of the HDR image data by the absolute brightness, the HDR image data method may be a method of defining the brightness of the HDR image data by the relative brightness, and a method of not defining the brightness of the HDR image data, either by the absolute brightness or the relative brightness, for example, are available. The case of using the absolute brightness as the input brightness was described above, but the relative brightness or the brightness value Y may be used as the input brightness.

An example of increasing the display brightness of the SDR pixel by correcting (changing) the pixel values of the SDR pixel was described above, but the display brightness of the SDR pixel may be increased by a different method. For example, the display brightness of the SDR pixel may be increased by increasing the emission brightness of the light-emitting unit (backlight unit) from the emission brightness that is set. One of correcting the pixel values and increasing the emission brightness of the light-emitting unit may be performed, or both may be performed. Further, the brightness control, to increase the display brightness of the SDR pixel, need not be performed.

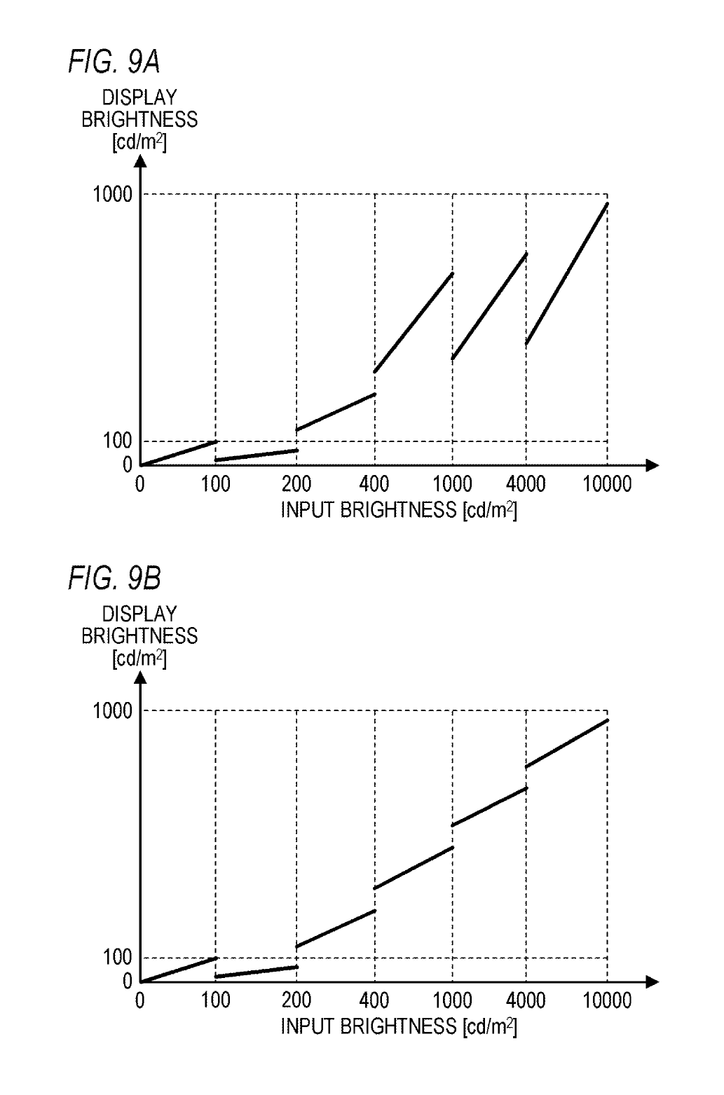

The correspondence of the input brightness and the display brightness need not be the correspondence in FIG. 8. For example, as indicated in FIGS. 9A and 9B, the display brightness of the conversion color may be discontinuously changed at the boundaries among the plurality of partial brightness ranges as the input brightness increases. The correspondence in FIG. 9A is acquired by using a value which is generated by multiplying the gradation values (R value, G value, B value) of the conversion color corresponding to the maximum brightness of the partial brightness range by 0.5, for the gradation values of the conversion color corresponding to the minimum brightness of the partial brightness range. Since the display brightness of the conversion color discontinuously changes at the boundaries among the plurality of partial brightness ranges as the input brightness increases, the user can easily know the boundaries among the plurality of partial brightness ranges.

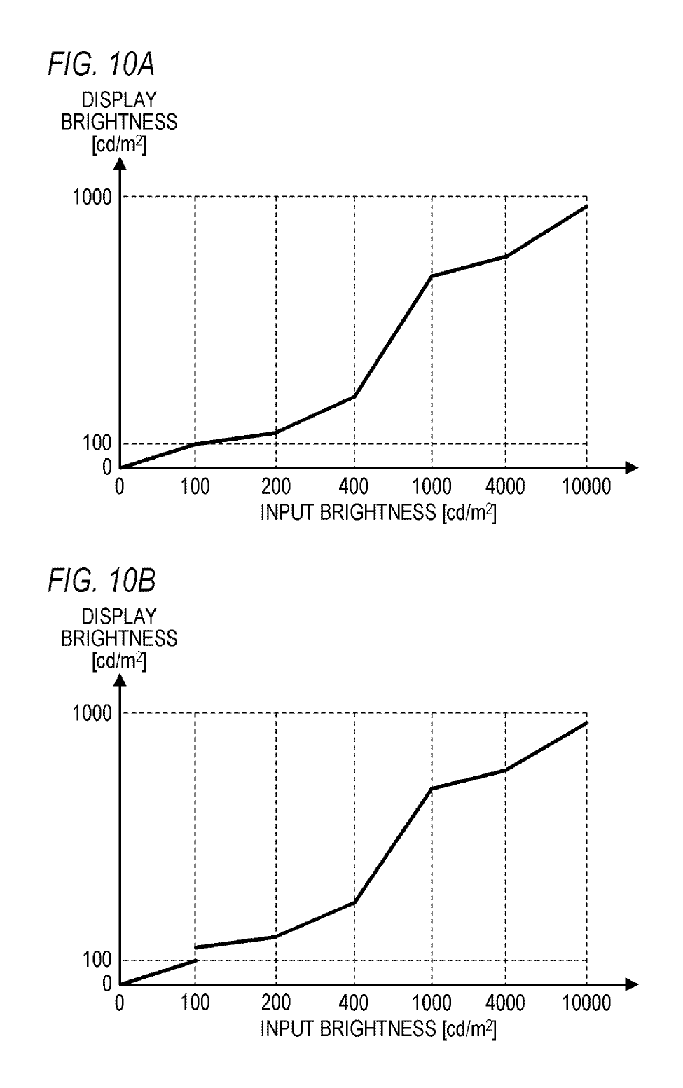

As indicated in FIGS. 10A and 10B, the display brightness of the conversion color may be determined such that the display brightness increases from a predetermined brightness (maximum brightness of SDR range) to a brightness higher than the predetermined brightness as the input brightness increases. In FIG. 10A, the display brightness of the display unit continuously increases from a predetermined brightness to a brightness higher than the predetermined brightness as the input brightness increases. In FIG. 10B, the display brightness of the display unit discontinuously increases from a predetermined brightness to a brightness higher than the predetermined brightness as the input brightness increases.

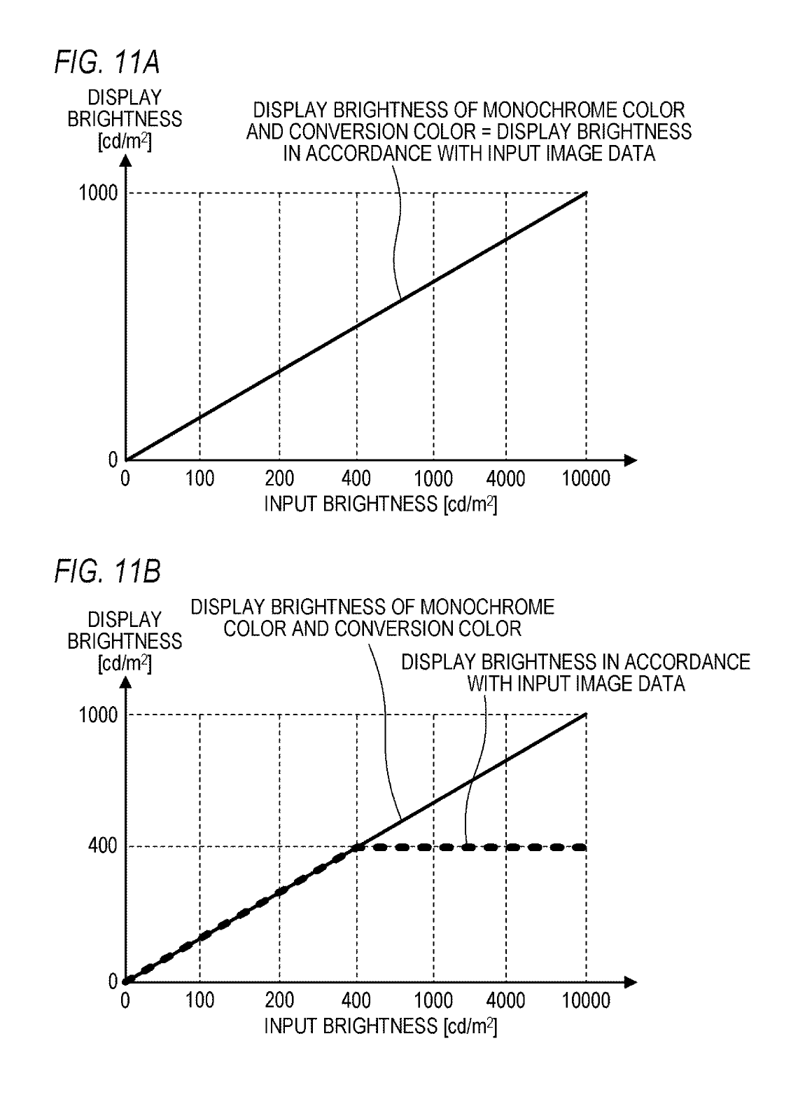

As indicated in FIG. 11A, the display brightness of the conversion color may be the same as the display brightness in accordance with the input image data. As indicated in FIG. 11B, the display brightness of the conversion color may be higher than the display brightness in accordance with the input image data.

As mentioned above, a pixel included in each partial brightness range is colored so as to be displayed at a display brightness corresponding to the high-low relationship in the range of the input brightness included in each partial brightness range. In other words, the color used for coloring of each partial brightness range is determined so that the average value of the brightness of the color used for coloring each partial brightness range increases as the range of the input brightness included in each partial brightness range is higher.

### Example 2

Example 2 of the present invention will be described next. In the following, the aspects (configuration, processing) that are different from Example 1 will be described in detail, and description on aspects that are the same as Example 1 will be omitted. In Example 2, the upper limit display brightness can be changed.

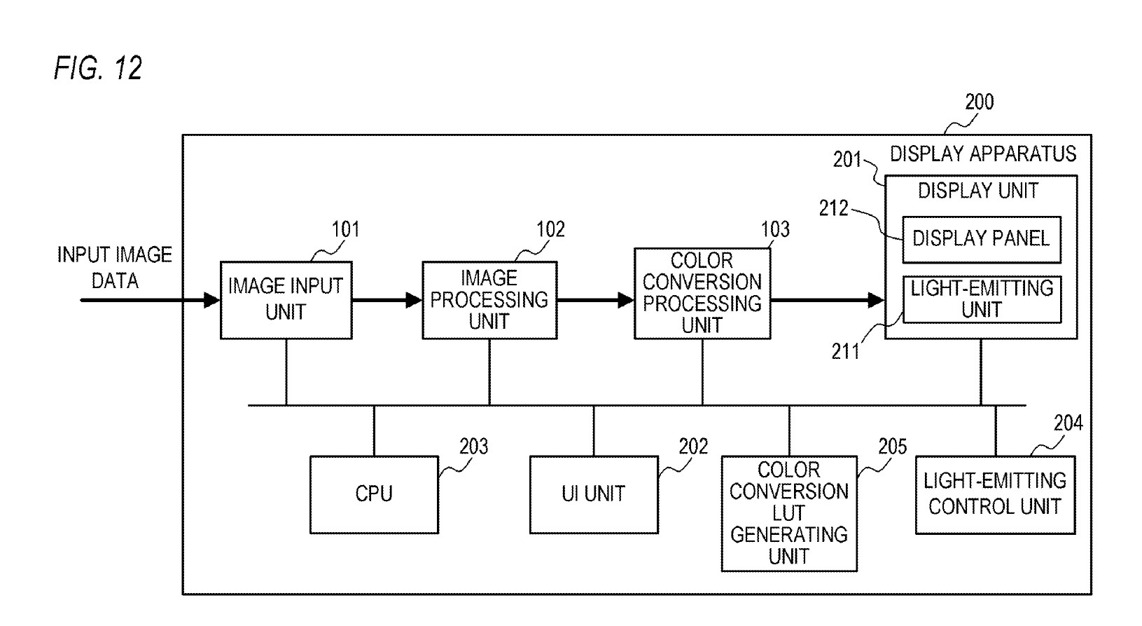

FIG. 12 indicates a configuration example of a display apparatus 200 according to Example 2. In FIG. 12, a function unit that is the same as Example 1 (FIG. 1) is denoted with the same reference sign as Example 1. A display apparatus 200 includes the image input unit 101, the image processing unit 102, the color conversion processing unit 103, a display unit 201, a UI unit 202, a CPU 203, a light-emitting control unit 204 and a color conversion LUT generating unit 205.

The display unit 201 has the same functions as the display unit 104 of Example 1. However the display unit 201 has a light-emitting unit 211 and a transmission type display panel 212. The light-emitting unit 211 irradiates light to the rear face of the display panel 212. The display panel 212 displays an image by transmitting through the light emitted from the light-emitting unit 211 based on the display image data.

The UI unit 202 has the same functions as the UI unit 106 of Example 1. Further, the UI unit 202 receives the user operation for setting brightness (setting the upper limit display brightness). The UI unit 202 outputs an operation signal, in accordance with the user operation for setting brightness, to the CPU 203.

The CPU 203 has the same functions as the CPU 105 in Example 1. Further, the CPU 203 sets the brightness in accordance with the operation signal of the user operation for setting brightness. The upper limit display brightness is not especially limited, but in Example 2, the upper limit display brightness that is at least 0 cd/m² and not more than 1000 cd/m² is assumed to be set.

The light-emitting control unit 204 controls the emission brightness of the light-emitting unit 211 in accordance with the upper limit display brightness. Therefore the brightness setting can be interpreted as “setting the emission brightness of the light-emitting unit 211”. The emission brightness in accordance with the upper limit display brightness is not especially limited, but is approximately the same as the upper limit display brightness, for example.

The color conversion LUT generating unit 205 has the same functions as the color conversion LUT generating unit 107 of Example 1. The color conversion LUT generating unit 205, however, determines the brightness gain of the SDR pixel in accordance with the display target range and the upper limit display brightness. The display brightness in accordance with the input image data depends on the upper limit display brightness. As the upper limit display brightness is lower, the display brightness in accordance with the input image data is lower, and as the upper limit display brightness is higher, the display brightness in accordance with the input image data is higher. Therefore the color conversion LUT generating unit 205 determines a higher brightness gain (degree of increase) as the upper limit display brightness is lower. As a result, the visibility of the image region in the SDR range improves, and the user can easily know the gradation of the image region in the SDR range with more certainty.

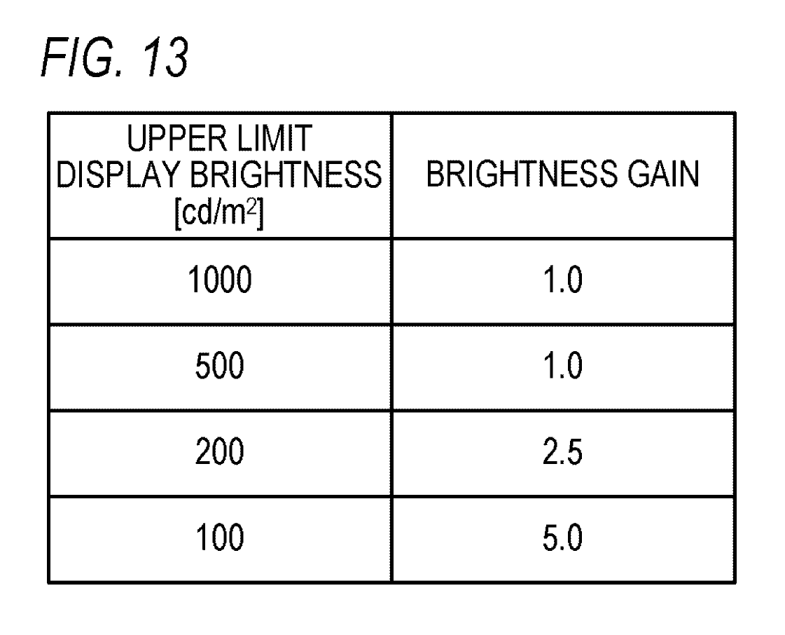

In concrete terms, when an upper limit display brightness that is at least 500 cd/m² is set, the color conversion LUT generating unit 205 determines the same brightness gain as the brightness gain of Example 1. When an upper limit display brightness that is less than 500 cd/m² is set, the color conversion LUT generating unit 205 determines a brightness gain that is greater than the brightness gain of Example 1. When the maximum brightness of the display target range is 1000 cd/m², the correspondence in FIG. 13 is used as the correspondence between the upper limit display brightness and the brightness gain. The correspondence between the upper limit display brightness and the brightness gain is not limited to the correspondence in FIG. 13. The brightness gain in accordance with the display target range and the brightness gain in accordance with the upper limit display brightness may be independently determined.

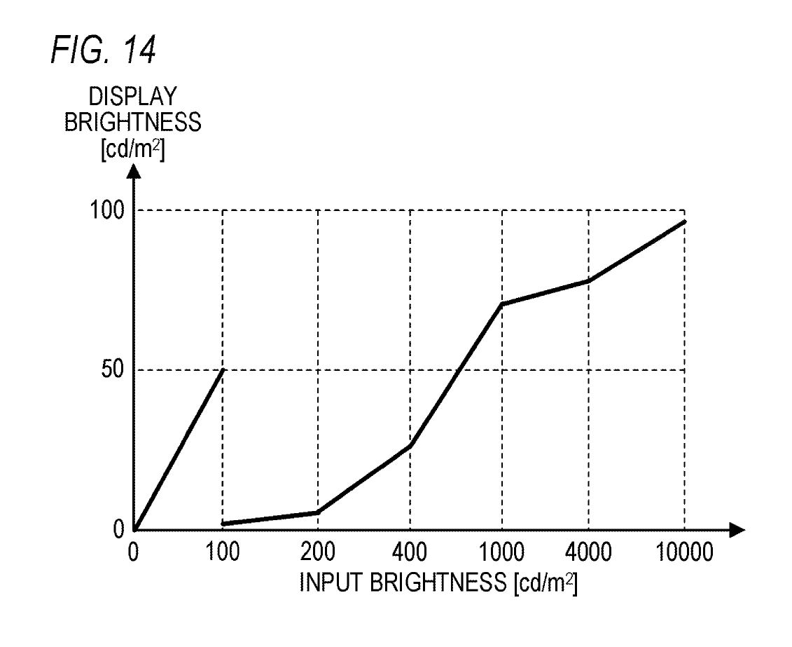

FIG. 14 indicates a correspondence between the input brightness and the display brightness in the case when the upper display brightness is set to 100 cd/m², and the display target range is set to at least 0 cd/m² and not more than 1000 cd/m², and when false color function is enabled. In FIG. 14, similarly to Example 1, the high-low relationship of the display brightness of the conversion color among a plurality of partial brightness ranges corresponds to the high-low relationship of the input brightness among the plurality of partial brightness ranges. As a result, the user can intuitively know that the display brightness of the conversion color corresponds to the input brightness, and can also intuitively know the distribution of the input brightness without knowing the actual correspondence between the input brightness and the conversion color.

When the upper limit display brightness is set to 100 cd/m² and the brightness gain “1.0” is used similarly to Example 1, the SDR range, that is at least 0 cd/m² and not more than 100 cd/m², is compressed to the display brightness range that is at least 0 cd/m² and not more than 10 cd/m², and is displayed in this compressed state. In Example 2, the brightness gain “5.0” is used, which means that the display brightness of the SDR pixel is increased to five times the display brightness in accordance with the input image data. Therefore the SDR range that is at least 0 cd/m² and not more than 100 cd/m² is displayed in the display brightness range that is at least 0 cd/m² and not more than 50 cd/m². As a result, the visibility of the image region in the SDR range improves, and the user can easily know the gradation of the image region in the SDR range.

As described above, according to Example 2, the display brightness of the SDR pixel is increased at a higher degree of increase as the upper limit display brightness is lower. As a result, the visibility of the image region in the SDR range improves, and the user can easily know the gradation of the image region in the SDR range with more certainty.

When the false color function is enabled and the upper limit display brightness is lower than a predetermined brightness, the light-emitting control unit 204 may control the emission brightness of the light-emitting unit 211 to an emission brightness that is higher than the emission brightness in accordance with the upper limit display brightness. For example, when the upper limit display brightness is set to a value that is lower than 500 cd/m², the light-emitting control unit 204 may control the emission brightness of the light-emitting unit 211 to an emission brightness in accordance with the upper limit display brightness 500 cd/m².

Each functional unit of Examples 1 and 2 may or may not be standalone hardware. The functions of two or more functional units may be implemented by common hardware. Each of a plurality of functions of one functional unit may be implemented by standalone hardware. Two or more functions of one functional unit may be implemented by common hardware. Each functional unit may or may not be implemented by hardware. For example, the apparatus may include a processor and a memory in which a control program is stored. Then the functions of at least a part of the functional units of the apparatus may be implemented by the processor reading the control program from the memory, and executing the control program.

Examples 1 and 2 are merely examples, and configurations implemented by appropriately modifying or changing the configurations of Examples 1 and 2 within the scope of the essence of the present invention are also included in the present invention. Configurations implemented by appropriately combining the configurations of Examples 1 and 2 are also included in the present invention.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-200407, filed on Oct. 16, 2017, which is hereby incorporated by reference herein in its entirety.

What is claimed is:

1. An image processing apparatus, comprising:
at least one processor and/or at least one circuit to perform the operations of the following units:
a converting unit configured to convert a color of a target region of an input image into a conversion color corresponding to a brightness of the target region; and
a display control unit configured to display an image on a display unit based on an image acquired by converting the color of the target region into the conversion color, wherein
in a case that the brightness of the target region is included in a first partial range among a plurality of partial ranges obtained by dividing a brightness range of the input image, the converting unit converts the color of the target region into a monochrome color,
in a case that the brightness of the target region is included in one of a plurality of second partial ranges, each of which is different from the first partial range, among the plurality of partial ranges, the converting unit converts the color of the target region into a conversion color corresponding to the one of the plurality of second partial ranges, and
regarding each of the plurality of second partial ranges, a brightness of the conversion color is higher as a brightness of the second partial range is higher.

2. The image processing apparatus according to claim 1, wherein
in each of the plurality of partial ranges, the brightness of the conversion color is higher as a brightness of the input image is higher.

3. The image processing apparatus according to claim 1, wherein
the number of the plurality of second partial ranges is at least three.

4. The image processing apparatus according to claim 1, wherein
the first partial range is a range in which a brightness of the input image is equal to or less than a predetermined brightness.

5. The image processing apparatus according to claim 1, the at least one processor and/or the at least one circuit to perform the operations of the following units;
a brightness control unit configured to increase a display brightness of a specific pixel corresponding to the first partial range from a display brightness in accordance with the input image.

6. The image processing apparatus according to claim 5, wherein
a display target range in the brightness range of the input image is changeable, and
the brightness control unit increases the display brightness of the specific pixel at a higher degree of increase as the display target range is wider.

7. The image processing apparatus according to claim 5, wherein
an upper limit of a display brightness of the display unit is changeable, and the brightness control unit increases the display brightness of the specific pixel at a higher degree of increase as the upper limit of the display brightness is lower.

8. The image processing apparatus according to claim 5, wherein
the brightness control unit increases the display brightness of the specific pixel at an increase rate that is set.

9. The image processing apparatus according to claim 5, wherein
the brightness control unit increases the display brightness of the specific pixel by performing at least processing to change a pixel value of the specific pixel.

10. The image processing apparatus according to claim 5, wherein
the display unit includes a light-emitting unit, and a display panel configured to display an image by transmitting light emitted from the light-emitting unit, and
the brightness control unit increases the display brightness of the specific pixel by performing at least processing to increase an emission brightness of the light-emitting unit from an emission brightness that is set.

11. The image processing apparatus according to claim 1, wherein
a brightness of the conversion color corresponding to a maximum brightness in the second partial range is higher as the maximum brightness is higher.

12. The image processing apparatus according to claim 1, wherein
a brightness of the conversion color corresponding to a minimum brightness in the second partial range is higher as the minimum brightness is higher.

13. The image processing apparatus according to claim 1, wherein
the brightness of the conversion color is the same as a brightness of the input image.

14. An image processing method, comprising:
converting a color of a target region of an input image into a conversion color corresponding to a brightness of the target region; and
displaying an image on a display unit based on an image acquired by converting the color of the target region into the conversion color, wherein
in the converting,
in a case that the brightness of the target region is included in a first partial range among a plurality of partial ranges obtained by dividing a brightness range of the input image, the color of the target region is converted into a monochrome color,
in a case that the brightness of the target region is included in one of a plurality of second partial ranges, each of which is different from the first partial range, among the plurality of partial ranges, the color of the target region is converted into a conversion color corresponding to the one of the plurality of second partial ranges, and
regarding each of the plurality of second partial ranges, a brightness of the conversion color is higher as a brightness of the second partial range is higher.

15. Anon-transitory computer readable medium that stores a program, wherein
the program causes a computer to execute:
converting a color of a target region of an input image into a conversion color corresponding to a brightness of the target region; and
displaying an image on a display unit based on an image acquired by converting the color of the target region into the conversion color, wherein
in the converting,
in a case that the brightness of the target region is included in a first partial range among a plurality of partial ranges obtained by dividing a brightness range of the input image, the color of the target region is converted into a monochrome color,
in a case that the brightness of the target region is included in one of a plurality of second partial ranges, each of which is different from the first partial range, among the plurality of partial ranges, the color of the target region is converted into a conversion color corresponding to the one of the plurality of second partial ranges, and
regarding each of the plurality of second partial ranges, a brightness of the conversion color is higher as a brightness of the second partial range is higher.
